(19) United States
(12) Patent Application Publication
(10) Pub. No.: US 2005/0000895 A1
(43) Pub. Date: Jan. 6, 2005

(54) Use of polymer as flocculation aid in membrane filtration

(76) Inventors: Jason Cadera, Guelph (CA); Pierre Lucien Cote, Dundas (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/887,876

(22) Filed: Jul. 12, 2004

Related U.S. Application Data
(63) Continuation-in-part of application No. 10/261,698, filed on Oct. 2, 2002.
(63) Continuation of application No. PCT/CA03/01504, filed on Sep. 30, 2003.
Application No. PCT/CA03/01504 is a continuation-in-part of application No. 10/261,698, filed on Oct. 2, 2002.

(51) Int. Cl. B01D 65/02

(52) U.S. Cl. 210/636; 210/702; 210/639; 210/650

(57) ABSTRACT

A method of filtering a feed of water to provide potable water includes adding a coagulant to the water to be filtered to encourage the formation of flocs. About 0.1 to 1 mg/L of a polymeric flocculation aid is also added to the water to be filtered to further encourage the formation of flocs. Some of the flocs may then removed from the water to be treated, for example with a clarifier. A filtered permeate is removed from the water to be treated with a membrane filtration device. The membrane filtration device may be an immersed suction driven membrane filtration device. The polymeric flocculation aid may be added to the body of water in a dosage between about 0.2 and 0.5 mg/L. The dosage of the polymeric flocculation aid may also be approximately equal to the dosage which gives the minimum turbidity of the water to be treated, for example, as determined by jar testing.

This is a continuation-in-part of U.S. Ser. No. 10/261,698 filed Oct. 2, 2002 and a continuation of PCT Application No. PCT/CA2003/001504 filed Sep. 30, 2003, which is a continuation-in-part of U.S. Ser. No. 10/261,698 filed Oct. 2, 2002. All of the applications listed above are incorporated herein, in their entirety, by this reference to them.

### FIELD OF THE INVENTION

The present invention relates to water filtration or treatment, and more particularly relates to filtering or treating water containing suspended and colloidal or other contaminants to provide potable water or other waters reduced in contaminants using membranes such as immersed suction driven membranes.

### BACKGROUND OF THE INVENTION

Raw water contains contaminants such as natural organic matter, bacteria, colour, turbidity, and insoluble impurities. These contaminants are present in the form of suspended, colloidal, and dissolved particles. Colloidal particles have an extremely small size, a large surface area to mass ratio, and negative surface charges that are measured as the Zeta potential. These small negatively charged particles repel each other in water and do not readily settle out of solution.

One type of chemical-physical water treatment process involves coagulation and flocculation. In coagulation, chemicals that dissociate to form positively charged particles are added to the water to neutralize and destabilize the negatively charged colloidal particles. Destabilized colloidal particles adhere to each other much more readily than negatively charged colloidal particles. In flocculation, the water is gently mixed to promote particle collisions that result in the formation of larger aggregate particles (commonly referred to as flocs). Most of these flocs can then be removed from the water, for example in a clarifier, and the water with most of the flocs removed sent to a filter, for example a membrane filter. Alternately, if a membrane filter is used, the membrane filter may be located directly in a tank containing floc, for example as described in U.S. Pat. No. 6,027,649. All of U.S. Pat. No. 6,027,649, issued on Jan. 22, 2000, is incorporated herein by this reference to it, as if it were fully set forth herein.

Coagulation aids include cationic (positive) polymers. These aids have been used in conventional drinking water treatment systems to enhance coagulation by helping to neutralize and destabilize the negatively charged colloidal particles. Flocculation aids include high molecular weight anionic (negative) or nonionic (neutral) polymers. Flocculation aids are large particles with high surface areas that increase the probability of particle collisions, thus enhancing flocculation. Flocculation aids have been used to improve settling in clarifiers. However, attempts to use polymeric flocculation aids with membranes have failed because the polymers have fouled the filtration membrane.

### SUMMARY OF THE INVENTION

It is an object of the invention to improve on the prior art. Further objects of the invention are to provide a membrane filtration or treatment method using polymeric flocculation aids and a means to determine a maximum dosage of the polymeric flocculation aid. The summary below is intended to introduce the reader to the invention which may consist of a combination or sub-combination of some or all of the elements or steps described below or in other parts of this document.

For example, a method of filtering a feed of water to provide potable water includes adding a coagulant to the water to be filtered to encourage the formation of flocs. About 0.1 to 1 mg/L of a polymeric flocculation aid is also added to the water to be filtered to further encourage the formation of flocs. A membrane filter, for example an immersed suction driven membrane filter, is used to remove a filtered permeate from the water to be treated. Optionally, some of the flocs may be removed from the water to be treated upstream of the filter, for example with a clarifier, centrifuge or flotation. The polymeric flocculation aid may be added to the water to be filtered in a dosage between about 0.2 and 0.5 mg/L. The dosage of the polymeric flocculation aid may also be approximately equal to the dosage which gives the minimum turbidity of the water to be filtered, for example, as determined by jar testing.

In another example, a method of filtering a feed of water to provide potable water includes adding about 0.1 to 1 mg/L of a polymeric flocculation aid to the water to be filtered to encourage the formation of flocs. A membrane filter, for example an immersed suction driven membrane filter, is used to remove a filtered permeate from the water to be treated. The dosage of the polymeric flocculation aid may also be approximately equal to the dosage which gives the minimum turbidity of the water to be filtered, for example, as determined by jar testing.

The invention may similarly be used to filter or treat other sorts of feed waters to produce water for other uses. For example, the feed water may be surface water, ground water, water from a municipal water treatment plant, or a wastewater, for example a secondary effluent from a municipal or industrial source. The treated water may be intended for use, optionally after further treatment, for a variety of purposes, for example as drinking water, as industrial process water, or as a discharge, for example to a municipal sewer or groundwater storage area. In some or all of these applications, the invention may be used in ways that vary from the examples summarized above. For example, a coagulant may not be required in some or all processes.

### BRIEF DESCRIPTION OF THE DRAWINGS

For a better understanding of the present invention, and to show more clearly how it may be carried into effect, reference will now be made, by way of example, to the accompanying drawings, which show a preferred embodiment of the present invention and in which:

FIG. 1 is a schematic diagram of a drinking water treatment system according to the present invention;

FIG. 2 is a graph for pilot plant tests according to a first example showing transmembrane pressure (kPa) as a function of time (days) where the coagulant, coagulation aid, and the flocculation aid are added to the raw water in a stepwise fashion;

FIG. 3 is a graph for jar tests and the pilot plant tests according to the first example showing supernatant turbidity after 10 minutes of settling time (NTU) and membrane fouling rate (kPa/day) as a function of flocculation aid dosage (mg/L), with the coagulant dosage and the coagulation aid dosage both held constant;

FIG. 4 is a graph for pilot plant tests according to the first example showing membrane permeability (gfd/psi) as a function of time (days);

FIG. 5 is a graph for pilot plant tests according to a second example showing transmembrane pressure (kPa) as a function of time (days) where the coagulant, coagulation aid, and the flocculation aid are added to the raw water in a stepwise fashion;

FIG. 6 is a graph for jar tests and pilot plant tests according to the second example showing the correlation between the supernatant turbidity after 10 minutes of settling (NTU) and membrane fouling rate (kPa/day) as a function of flocculation aid dosage (mg/L), with the coagulant dosage and the coagulation aid dosage both held constant;

### DETAILED DESCRIPTION OF THE INVENTION

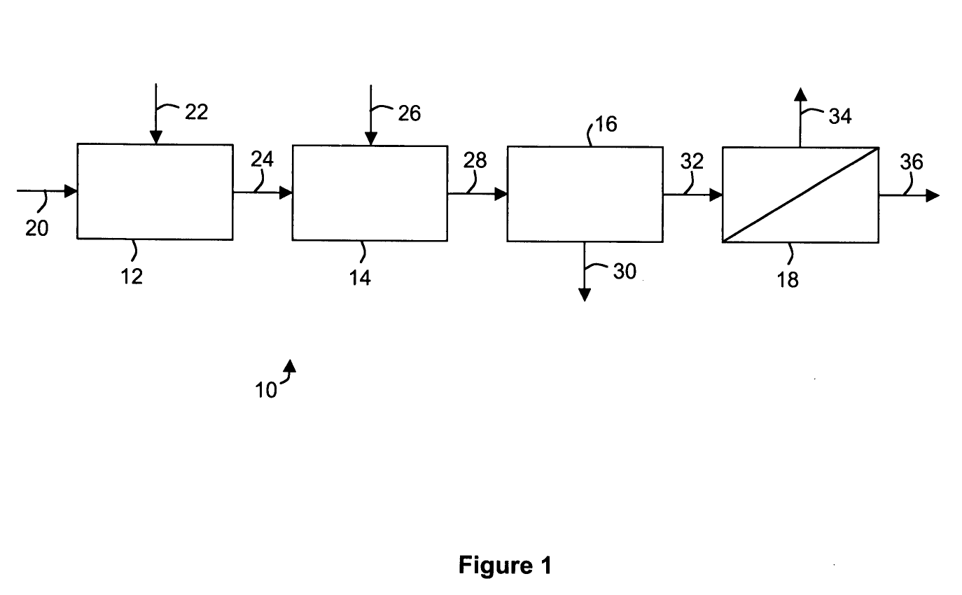

Referring first to FIG. 1, a drinking water treatment system according to the present invention is shown generally at 10. The system generally comprises a static mixer 12, a flocculation tank 14, a clarifier 16, and a filtration means 18, all of which are fluidly connected. The clarifier 16 is optional and may be replaced by other devices, for example a hydrocyclone or a flotation tank. Alternately, the filtration means 18 may be placed directly in the flocculation tank 14 although the inventors have observed that the improvement in performance provided by the invention is greater when a clarifier 16 is used.

Untreated feed water is introduced into the static mixer 12 through line 20. The untreated water is treated with a coagulant, which may be added to the static mixer 12 through line 22. The water is thoroughly mixed to ensure rapid dispersion of the coagulant. Optionally, a coagulation aid may be added to the static mixer 12 through line 22. The negatively charged colloidal particles are neutralized and destabilized in the static mixer 12. Optionally, an acid or alkali may be added to the static mixer 12 to maintain the pH at an optimum level.

The water is withdrawn from the static mixer 12 through line 24, and enters the flocculation tank 14. The water in the flocculation tank 14 is gently mixed to promote particle collisions, resulting in the formation and growth of flocs. A flocculation aid may be introduced into the flocculation tank 14 through line 26.

The water is withdrawn from the flocculation tank 14 through line 28, and enters the clarifier 16. A sedimentation layer is formed at the bottom of the tank, and may be removed through line 30.

The supernatant liquid is withdrawn from the clarifier 16 through line 32, and enters the filtration means 18. The filtration means 18 is one or more ultra filtration or micro filtration membranes or membrane assemblies, for example one or more modules of immersed hollow fibre membranes such as those sold under the trade mark Zee Weed” by Zenon Environment Inc. and described in Canadian Patent No. 2,227,692 which is fully incorporated herein by this reference to it, located in an open tank. The contaminants are rejected by the filtration means 18, forming a retentate that is removed through line 34. The permeate (filtered water) is removed from the filtration means 18 through line 36. When no clarifier 16 is used, the filtration means 18 is fed by the processed water produced by any device, for example an alternate separation device, downstream of the flocculation tank 14, or the feed side of the filtration means 18 is in direct fluid communication with the contents of the flocculation tank 14.

In the present invention, the water to be treated may be subject to pre-filtration (not shown), for example, to remove solids and debris that may interfere with the treatment in the system 10.

Various coagulants may be used which precipitate colloidal impurities such as natural organic matter, turbidity, colour causing compounds, and metals. The resulting floc formed offers an active surface area for the adsorption of soluble matter and other fine particulate matter, such as smaller organic molecules and viruses. The coagulant may be a cationic molecule that has a high charge density, a low molecular weight, and a relatively low activity level and may have a 100% positive charge density, a low molecular weight, and an activity of about 33%. Coagulants can include, but are not limited to, one or any combination of the following: aluminum salts such as polyaluminum chloride (PACL), aluminum sulfate, aluminum chloride, aluminum potassium sulfate, aluminum nitrate, and ferric salts such as ferric chloride.

The coagulant can be added to the system 10 in dosages of between about 5 to 200 mg/L, or between about 5 to 50 mg/L, for example about 30 mg/L. Alternately, use of a coagulant may be omitted.

Coagulation aids may be used which enhance coagulation of the colloidal particles. The coagulation aid may be a cationic molecule which has a high charge density, a low molecular weight, and a medium activity, and may have a 100% positive charge density, a low molecular weight and an activity of about 55%. For example, NALCO N8105™, which is available from Ondeo Nalco may be used. NALCO N8105™ is a solution that contains cationic molecules having a high charge density and a low molecular weight. The coagulation aid can be added to the system in dosages of between about 0.1 to 2.0 mg/L, for example about 1.6 mg/L. Optionally, coagulation aids may be omitted.

The inventors have found that a polymeric flocculation aid enhances growth of the flocs and may be an anionic, nonionic or a cationic. For example, the flocculation aid may be an anionic polymer with a low charge density, a high molecular weight and an activity between about 25% and 30%. A suitable anionic polymer is, for example, NALCO N8182™, which is available from Ondeo Nalco. NALCO 8182™ is an emulsion that contains anionic molecules having a low charge density and a high molecular weight. A suitable cationic flocculant is, for example, NALCO N7190+™, which is also available from Ondeo Nalco. NALCO N7190+™ is an emulsion that contains cationic molecules having a very low charge density and a high molecular weight.

If the amount of polymeric flocculation aid added is too high, the filtration means 18 will foul rapidly and will require extensive chemical cleaning to restore a reasonable portion of it's permeability. In particular, adding a polymeric flocculation aid to the water to be filtered at a dose of greater than 1.5 ppm is likely to cause a significant increase in the fouling rate of the filtration means 18. However, at lower doses of the polymeric flocculation aid, for example, less than 1.0 ppm or between 0.1 and 0.5 ppm, minimal, if any, increase in the fouling rate of the filtration means 18 occurs. Further, a reasonable portion of the initial permeability of the filtration means 18, for example, more than 70% of the initial permeability, can be recovered with moderate or ordinary chemical cleaning such that the permeability of the filtration means can be maintained at or above a reasonable level, for example, 70% or more of the initial permeability, over a period of several months.

A preferred dosage of the polymeric flocculation aid may be determined by trial and error. The inventors believe that problems experienced in the past with polymeric flocculation aids and ultra filtration or micro filtration membranes, particularly problems of irreversible membrane fouling, may have resulted from using dosages of the flocculation aids which left active polymer available to combine with and foul the membrane material. By using appropriate dosages of polymeric flocculation aids, the flocculation aid is more completely reacted with particles in the water to be treated and so have less ability to foul the membrane material. The inventors have also found that by using appropriate dosages of polymeric flocculation aids, an acceptable fouling rate can be achieved and that the fouling can be at least partially reversed, for example by ordinary chemical recovery cleaning such as with NaOCl.

The trial and error process suggested above may be modified to use jar testing. In particular, jar tests may be performed on the feed water. The dosage of the polymeric flocculation aid is varied and the ability of the solids in the feed water to settle tested at each dosage. The inventors have noticed that the polymer dose which corresponds with the minimum supernatant turbidity in a jar test correlates with the minimum membrane fouling rate. Accordingly, the polymer dose which results in the minimum supernatant turbidity is used to determine the approximate maximum allowable polymeric flocculation aid dosage.

The following non-limiting examples are illustrative of the present invention:

### EXAMPLE 1

In this example, pilot plant tests were conducted to analyze the effect of the addition of primary coagulants, coagulant aids and flocculation aids on the rate of membrane fouling. Table 1 below outlines the properties of the chemicals used for these tests.

TABLE 1

| | | Charge | Charge | Molecular | |
|---|---|---|---|---|---|
| Chemical | Form | Type | Density | Weight | Activity |
| Stern | Solution | Primary | 100% | Low | 33% |
| PACL | | cationic | positive | | |
| | | coagulant | | | |
| Nalco | Solution | Cationic | 100% | Low | 55% |
| N8105 ™ | | coagulation | positive | | |
| | | aid | | | |
| Nalco | Solution | Anionic | Low | High | 29% |
| N8182 ™ | | flocculant | | | |
| | | aid | | | |

The pilot plant system consisted of a static mixer, a flocculation tank, a clarifier and a Zeeweed” membrane tank. In this example, two sets of pilot plant tests were conducted, using two different membrane modules, called W-101 036 and W-100-139, built to the same design. These tests were run in successive stages, that is; at each stage a chemical was added to the system to see the cumulative effect on the rate of membrane fouling.

At each stage in the pilot plant test, the following operating parameters were kept constant: the net permeate flux was 25 gdf, the back pulse flux was 27 gdf, the production/back pulse cycle was 9.75/15 min/sec, the air flow was continuous at 2 scfm, the feed flow rate was 2 L/min, the feed was a lake water, the hydraulic retention time (HRT) in the flocculation tank was 25 min, the HRT in the Zeeweed™ membrane tank was 60 min, the HRT in the clarifier was 35 min, and the recovery rate in the membrane tank was 95%.

Table 2 below shows the primary coagulant, coagulation aid, and flocculation aid dosages present during the various stages of the process.

TABLE 2

| Chemical Additive | Stage 1 | Stage 2 | Stage 3 | Stage 4 | Stage 5 |
|---|---|---|---|---|---|
| Stem PACL (mg/L) | 30 | 30 | 30 | 30 | 30 |
| Nalco N8105 ™ (mg/L) | 0 | 1.6 | 1.6 | 1.6 | 1.6 |
| Nalco N8182 ™ (mg/L) | 0 | 0 | 0.5 | 1 | 1.5 |

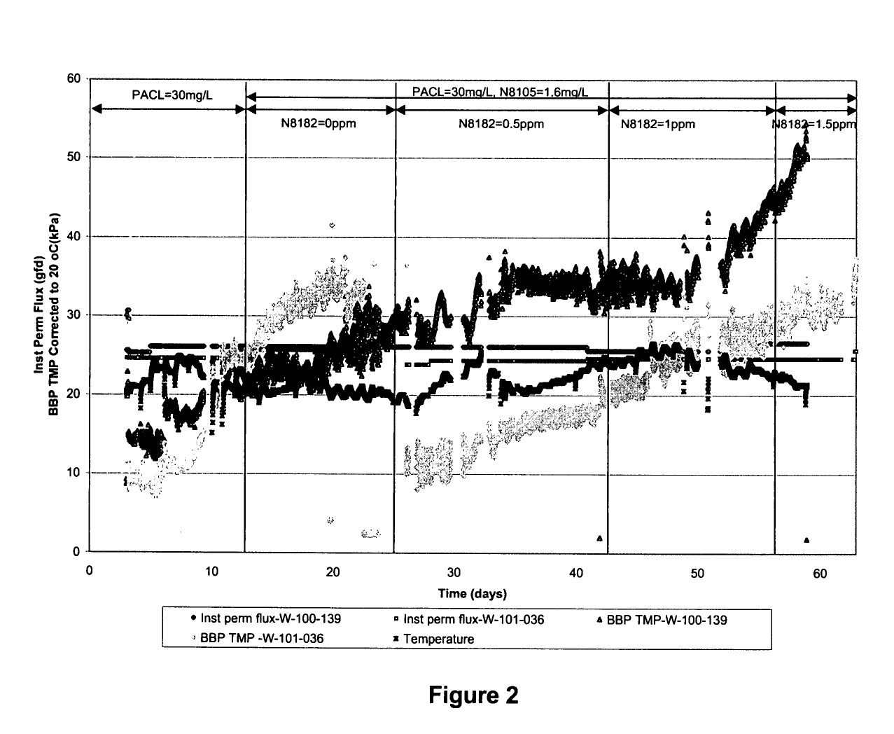

Referring now to FIG. 2, a graph shows transmembrane pressure (kPa) as a function of time (days) where the coagulant, coagulation aid, and the flocculation aid were added to the raw water in a stepwise fashion. Generally, the membrane fouling rate decreased with the introduction of the coagulation aid Nalco N8105™ at a dosage of 1.6 mg/L. The membrane fouling rate reached a minimum value with the addition of flocculation aid Nalco N8182™ at a dosage of 0.5 mg/L. At flocculation aid dosages of 1 and 1.5 mg/L, the membrane fouling rate increased significantly for module W-100-139, and increased slightly for module W-101-036.

Jar tests were also conducted to optimize the dosage of the flocculation aid. Jar tests were conducted as known in the art. All of the jars contained 30 mg/L of the primary coagulant (Stern PACL (polyaluminum chloride), and 1.6 mg/L of the coagulation aid (Nalco N8105). The flocculation aid was added to the various jar tests in dosages of 0 mg/L, 0.5 mg/L, 1 mg/L and 1.5 mg/L.

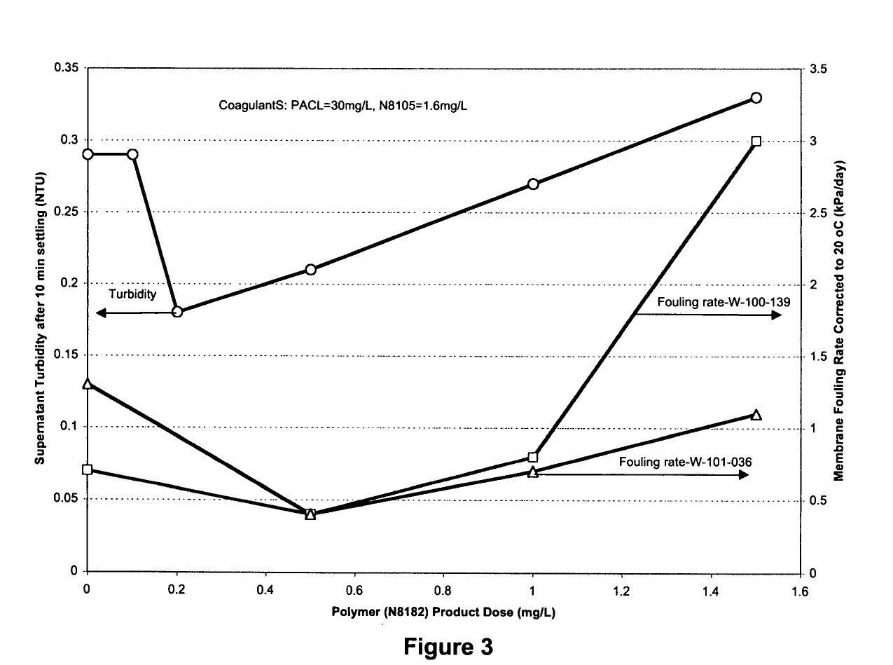

Referring now to FIG. 3, a graph shows supernatant turbidity after 10 minutes of settling time (NTU) and membrane fouling rate (kPa/day) as a function of flocculation aid dosage (mg/L), with the coagulant dosage held constant at 30 mg/L, and the coagulation aid dosage held constant at 1.6 mg/L. The jar tests suggest that the minimum supernatant turbidity (highest separation efficiency) of the feed water occurred when the flocculation aid dosage was in the range of about 0.2 mg/L to 0.5 mg/L. This range corresponds to the minimum fouling rate as shown in FIG. 2.

### EXAMPLE 2

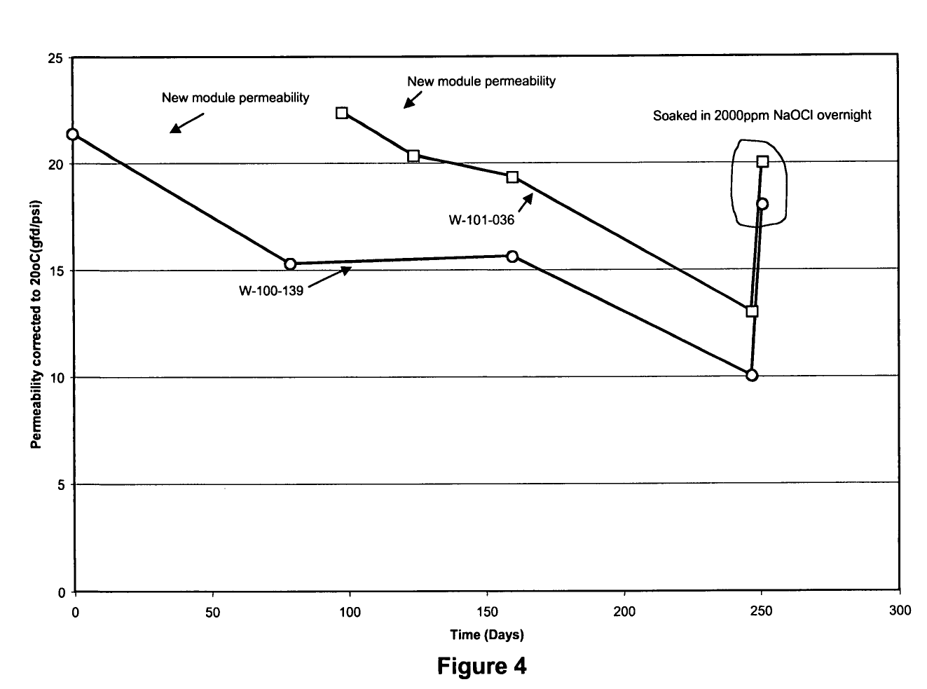

Referring now to FIG. 4, a graph shows membrane permeability (gfd/psi) as a function of time (days) for membranes operated with a polymeric flocculation aid (Nalco N8182™) at various concentrations up to about 1.5 mg/L for about 160 days. This graph suggests that there is no significant loss in permeability of the two modules after 3-4 months of operation with the addition of the flocculation aid. Moreover, the permeability of the W-100-139 module is maintained at over 70% of its original permeability after 5 months of operation with the addition of the flocculation aid. This reduction in permeability is comparable to that of a system that does not use the flocculation aid.

After about 160 days, the concentration of the polymeric flocculation aid ranged up to about 2.5 mg/L. Permeability decreased more rapidly. A first recovery treatment with 500 mg/L NaOCl and 2 g/L MC-1 recovered about 50% of the original permeability for both modules. A second recovery treatment with NaOCl (soaking overnight) recovered the permeability of the membranes to about 82-90% of their original permeability. This recovery of permeability is comparable to that of a system that does not use a flocculation aid.

### EXAMPLE 3

This example is the same as example 1, except as described below. The pilot plant tests were run under the same parameters, except for the net permeate flux which was changed to 25 gfd. Moreover, the dosages of the flocculation aid for both the pilot plant tests and jar tests were changed to further study the effect of the polymer on separation efficiency and rate of membrane fouling. Table 3 below shows the primary coagulant, coagulation aid, and flocculation aid dosages present during the various stages of the process.

TABLE 3

| Chemical Additive | Stage 1 | Stage 2 | Stage 3 | Stage 4 | Stage 5 |
|---|---|---|---|---|---|
| Stern PACL (mg/L) | 30 | 30 | 30 | 30 | 30 |
| Nalco N8105 ™ (mg/L) | 0 | 1.6 | 1.6 | 1.6 | 1.6 |
| Nalco N8182 ™ (mg/L) | 0 | 0 | 0.3 | 1.5 | 2.5 |

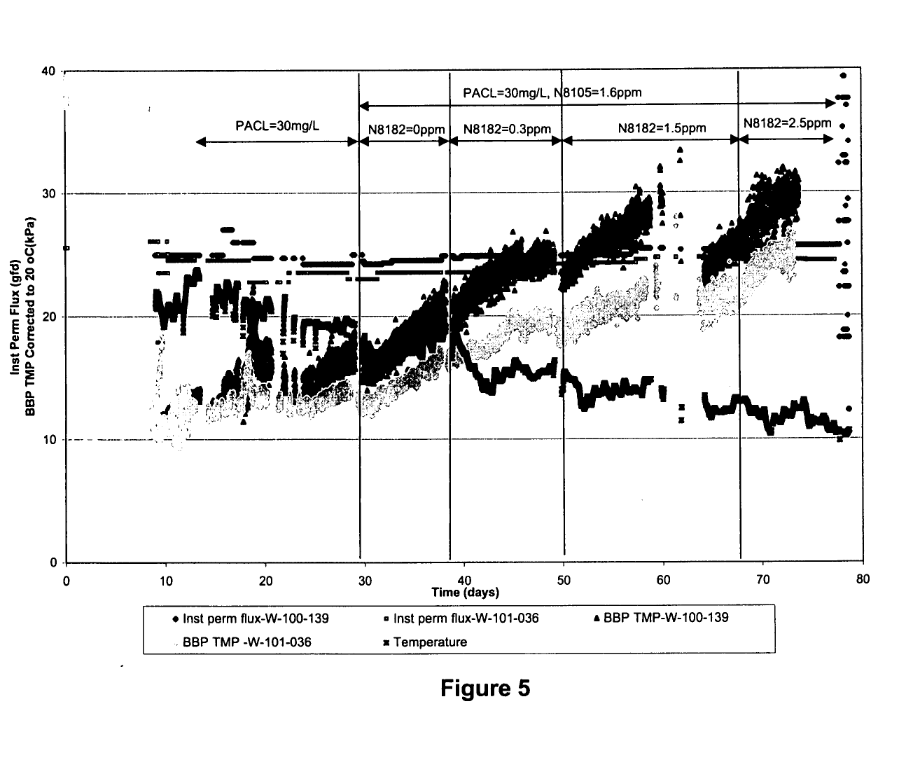

Referring now to FIG. 5, a graph shows transmembrane pressure (kPa) as a function of time (days) where the coagulant, coagulation aid, and the flocculation aid were added to the raw water in a stepwise fashion. In this example, the membrane fouling rate did not change with the introduction of the coagulation aid Nalco N8105™ at a dosage of 1.6 mg/L. The membrane fouling rate reached a minimum value with the addition of flocculation aid Nalco N8182™ at a dosage of 0.3 mg/L. At flocculation aid dosages of 1.5 and 2.5 mg/L, the membrane fouling rate increased significantly for both of the membrane modules.

Jar tests were also conducted to optimize the dosage of the flocculation aid. Jar tests were conducted as known in the art. All of the jars contained 30 mg/L of the primary coagulant (Stern PACL (polyaluminum chloride), and 1.6 mg/L of the coagulation aid (Nalco N8105™). The flocculation aid was added to the various jars in dosages of 0 mg/L, 0.3 mg/L, 1.5 mg/L and 2.5 mg/L.

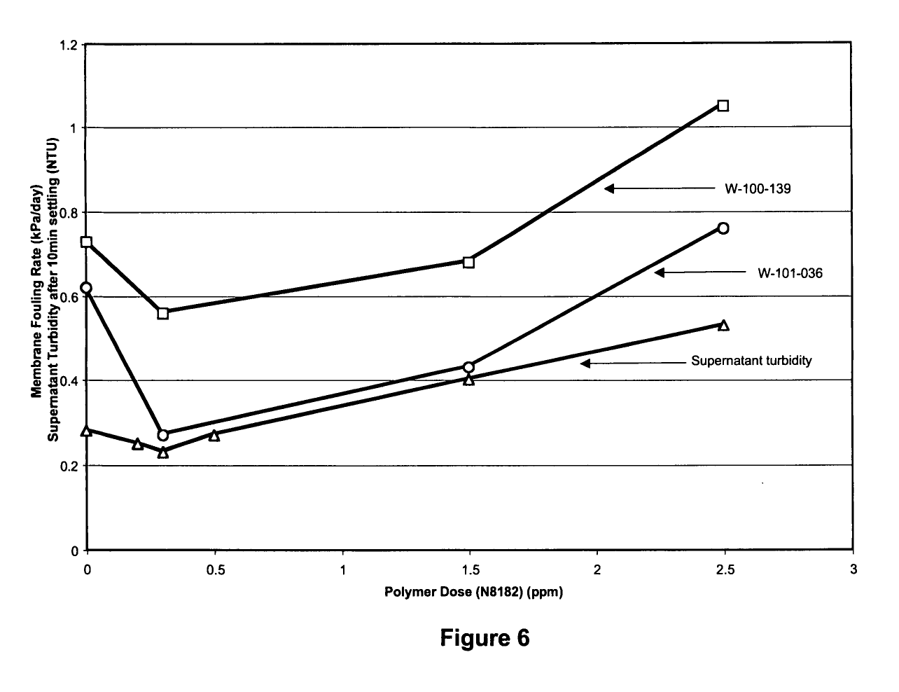

Referring now to FIG. 6, a graph shows supernatant turbidity after 10 minutes of settling time (NTU) and membrane fouling rate (kPa/day) as a function of flocculation aid dosage (mg/L), with the coagulant dosage held constant at 30 mg/L, and the coagulation aid dosage held constant at 1.6 mg/L. The jar tests suggest that the minimum supernatant turbidity (highest separation efficiency) occurred when the flocculation aid dosage was in the range of about 0.2 mg/L to 0.3 mg/L. This range corresponds to the minimum fouling rate as shown in FIG. 5.

While the above description constitutes the preferred embodiments, it will be appreciated that the present invention is susceptible to modification and change without departing from the fair meaning or the proper scope of the invention. For example, and without limitation, the invention has been described primarily for use in water filtration, for example where biological activity is not encouraged in the feed water, but the invention may also be useful with other sorts of water treatment. The invention is defined in the following claims.

1. A method of filtering water comprising the steps of:
(a) providing a feed of water to be filtered;
(b) adding between about 0.1 to 1.0 mg/L of a polymeric flocculation aid to the water to be filtered to encourage the formation of flocs; and
(c) removing a filtered permeate from the water to be treated with a membrane filtration device.

2. A method according to claim 1, further comprising the step of adding a coagulant to the water to be filtered to encourage the formation of flocs prior to step (b).

3. A method according to claim 1, wherein the membrane filtration device is an immersed suction driven membrane filtration device.

4. A method according to claim 1 wherein the membrane filtration device comprises polymeric membranes.

5. A method according to claim 1 wherein the membrane filtration device has a pore size of 10,000 or less.

6. A method according to claim 1, wherein some of the flocs are removed from the water to be treated upstream of the membrane filtration device.

7. A method according to claim 1 wherein the water to be filtered flows directly to the membrane filtration device after step (b).

8. A method according to claim 1 wherein step (b) is performed in a tank containing the membrane filtration device.

9. A method according to claim 1, wherein some of the flocs are removed from the water to be treated upstream of the membrane filtration device in a clarifier and the filtered permeate is removed from a supernatant from the clarifier.

10. A method according to claim 1, wherein the polymeric flocculation aid is added to the body of water in a dosage between about 0.2 and 0.5 mg/L.

11. A method according to claim 1, wherein the polymeric flocculation aid is anionic, has a low charge density, a high molecular weight, and an activity in the range of 25% to 30%.

12. A method according to claim 1, wherein the polymeric flocculation aid is added to the body of water in a dosage of about 0.3 mg/L.

13. A method according to claim 1, wherein the feed water to be filtered is intended to be used to produce drinking water.

14. A method according to according to claim 1, wherein the feed water to be filtered is intended to be used as industrial process water.

15. A method according to according to claim 1, wherein the feed water to be filtered is wastewater or secondary effluent from municipal or industrial sources.

16. A method according to claim 1 wherein the membrane filtration device is chemically cleaned to maintain a permeability of 70% or more of an initial permeability of the membrane filtration device.

17. A method according to claim 16 wherein the membrane filtration device is chemically cleaned with NaOCl.

18. A method according to claim 1 wherein the growth of organisms is not encouraged in the water to be filtered or treated.

19. A method of treating water, the method comprising the steps of:
(a) providing a feed of water to be filtered;
(b) adding a dosage of a polymeric flocculation aid to the water to be treated to cause at least a portion of the contaminants to form flocs therein; and,
(c) treating the water to be treated with a membrane filtration device, wherein the dosage of the polymeric flocculation aid is approximately equal to the dosage which gives the maximum settleability of the water to be treated flowing to the membrane filtration device.

20. A method according to claim 19, further comprising the step of adding a coagulant to the water to be filtered to cause at least a portion of the contaminants to form flocs therein prior to step (b).

21. The method according to claim 19, wherein the settleability of the water to be treated flowing to the membrane filtration device is determined by one or more jar tests.

22. The method according to claim 19, wherein a substantial portion of the flocs are removed from the water to be treated upstream of the membrane filtration device.

23. The method according to claim 22, wherein the substantial portion of flocs are removed by a clarifier.

24. A method according to claim 19, wherein the feed water to be filtered is intended to be used to produce drinking water.

25. A method according to claim 19, wherein the feed water to be filtered is intended to be used as industrial process water.

26. A method according to claim 25, wherein the feed water to be filtered is wastewater or secondary effluent from municipal or industrial sources.

27. A method according to claim 19 wherein the polymeric flocculation aid is anionic.
